(19) United States
(12) Patent Application Publication
(10) Pub. No.: US 2024/0202537 A1
(43) Pub. Date: Jun. 20, 2024

(54) LEARNING METHOD, LEARNING DEVICE, CONTROL METHOD, CONTROL DEVICE, AND STORAGE MEDIUM

(71) Applicant: KABUSHIKI KAISHA TOSHIBA, Tokyo (JP)

(72) Inventors: Ryosuke NONAKA, Yokohama (JP); Toshimitsu KANEKO, Kawasaki (JP)

(73) Assignee: KABUSHIKI KAISHA TOSHIBA, Tokyo (JP)

(21) Appl. No.: 18/460,113

(22) Filed: Sep. 1, 2023

(30) Foreign Application Priority Data
Dec. 19, 2022 (JP) 2022-202278

(51) Int. Cl. G06N 3/092

(52) U.S. Cl. CPC G06N 3/092

(57) ABSTRACT

According to one embodiment, a learning method includes calculating a probability distribution indicating a distribution of a probability density or a distribution of a probability at which actions are selected, selecting a first action based on the probability distribution, causing a control target to execute the first action, receiving a reward and next observation data, calculating a probability density or a probability of the first action, correcting the reward, and updating the control parameter. The reward is corrected such that the reward increases as the probability density or probability decreases.

### CROSS-REFERENCE TO RELATED APPLICATIONS

This application is based upon and claims the benefit of priority from Japanese Patent Application No. 2022-202278, filed Dec. 19, 2022, the entire contents of which are incorporated herein by reference.

### FIELD

Embodiments described herein relate generally to a learning method, a learning device, a learning program, a control method, a control device, and a control program.

### BACKGROUND

A machine learning method (also referred to as a reinforcement learning method) is known. A process of selecting an action of a control target, causing the control target to execute the selected action, and evaluating the action of the control target which corresponds to the executed action is repeated. The reinforcement learning method is applied to the action control of mobile objects such as automobiles, robots, and drones or movable objects such as robotic arms. In the reinforcement learning method, learning may converge to a local optimum in the early stage of learning.

### BRIEF DESCRIPTION OF THE DRAWINGS

FIG. 1 is a block diagram illustrating an example of a control target and a learning device that executes a learning method according to a first embodiment.

FIG. 2A is a diagram illustrating an example of a robotic arm as the control target.

FIG. 2B is a diagram illustrating an example of a robotic arm as the control target.

FIG. 3 is a flowchart illustrating an example of a control parameter learning method executed by the learning device according to the first embodiment.

FIG. 4 is a diagram illustrating an example of a neural network in which the parameters of a probability distribution are calculated.

FIG. 5 is a diagram illustrating an example of the relationship between the probability density Π₁(aₜ) at which the action aₜ is selected and the second reward.

FIG. 6 is a diagram illustrating an example of a neural network to calculate an estimate of a cumulative reward according to the first embodiment.

FIG. 7 is a diagram illustrating problems of a general reinforcement learning method.

FIG. 8 is a diagram illustrating an advantage of the control parameter learning method according to the first embodiment.

FIG. 9 is a block diagram illustrating an example of a control device that executes the control method according to the first embodiment and an example of the control target.

FIG. 10 is a flowchart illustrating an example of a control method to be executed by the control device according to the first embodiment.

FIG. 11 is a flowchart illustrating an example of a control parameter learning method to be executed by the learning device according to the second embodiment.

FIG. 12 is a diagram illustrating an example of a neural network to calculate a probability distribution according to the second embodiment.

FIG. 13 is a diagram illustrating an example of the relationship between the probability Π₂(aₜ) at which the action aₜ is selected and the second reward.

FIG. 14 is a flowchart illustrating an example of a control parameter learning method to be executed by the learning device according to the third embodiment.

FIG. 15 is a diagram illustrating an example of a neural network to calculate the action value Q(a) when the control target executes a discrete action.

FIG. 16 is a flowchart illustrating an example of the learning method according to the fourth embodiment.

### DETAILED DESCRIPTION

Various embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes, and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

In general, according to one embodiment, a learning method comprises a first step of receiving current observation data; a second step of calculating a probability distribution indicating a distribution of a probability density or a distribution of a probability at which actions are selected, based on the current observation data and a control parameter; a third step of selecting a first action among the actions based on the probability distribution; a fourth step of causing a control target to execute the first action; a fifth step of receiving a first reward and next observation data observed after the control target has executed the first action; a sixth step of calculating a probability density or a probability of the first action from the probability distribution; a seventh step of correcting the first reward based on a probability density of the first action or a probability of the first action; and an eighth step of updating the control parameter based on the current observation data, the first action, the next observation data, and the corrected first reward. The seventh step comprises correcting the first reward such that the first reward increases as the probability density or probability decreases.

### First Embodiment

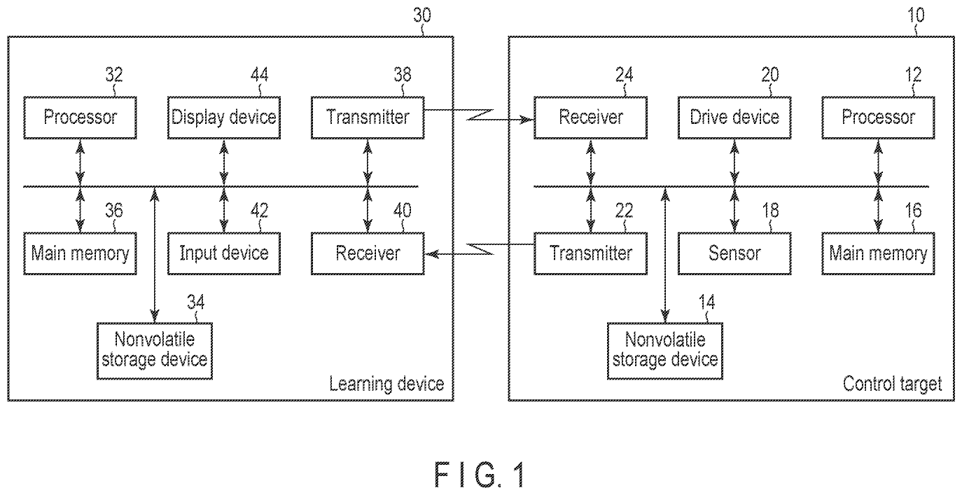

FIG. 1 is a block diagram illustrating an example of a control target 10 and a learning device 30 that executes a learning method according to a first embodiment.

The learning device 30 is electrically connected to the control target 10. The electrical connection between the learning device 30 and the control target 10 may be wired or wireless. If the control target 10 is a mobile object such as an automobile, a robot, and a drone, the learning device 30 and the control target 10 may be connected wirelessly.

The learning device 30 uses a reinforcement learning method which executes action control stochastically and optimizes control parameters. Examples of the reinforcement learning method include various methods such as the actor-critic method and the SARSA method. Both the methods are available in the first embodiment. In the first embodiment, the actor-critical method is used as an example.

The learning device 30 receives various information items from the control target 10. The information items concern the status of the control target 10 itself and that of the surrounding environment of the control target 10. The learning device 30 selects an action to be executed by the control target 10 using the information items to cause the control target 10 to execute the selected action. The learning device 30 learns control parameters such that the control target 10 can select an appropriate action in accordance with the status of the control target 10 itself and that of the surrounding environment of the control target 10.

To evaluate whether an appropriate action has been selected, the learning device 30 receives a reward for the execution of the action. The reward indicates whether selection of the action was appropriate. The learning device 30 learns the selection of action of the control target 10 and reflects a result of the learning in the values of the control parameters such that the action is selected more frequently if a cumulative reward obtained in the future by executing the action is large and the action is selected less frequently if the cumulative reward is small.

The actions of the control target 10 include a continuous action and a discrete action. The first embodiment is applicable to any of the actions. In the following description, the action of the control target 10 is the continuous action.

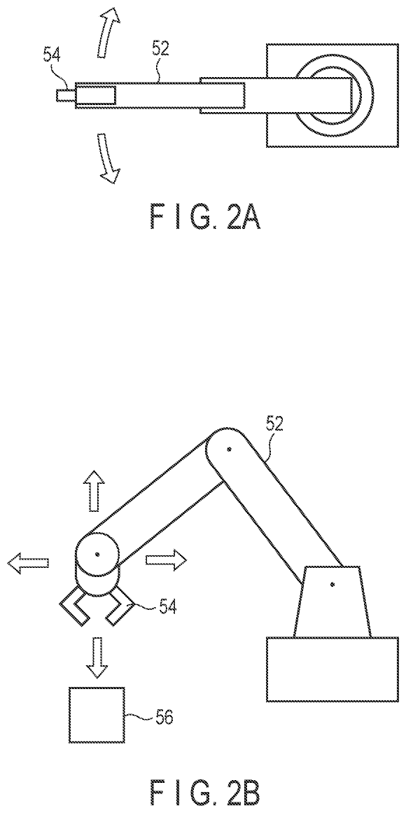

FIGS. 2A and 2B are diagrams illustrating an example of a robotic arm 52 as the control target 10. FIG. 2A is a diagram of the robotic arm 52 when viewed from the top. FIG. 2B is a diagram of the robotic arm 52 when viewed from the side. The robotic arm 52 has an end effector 54 at its end. The end effector 54 grips an item 56. Examples of the continuous action to be controlled by the robotic arm 52 include an amount of vertical displacement of the end effector 54 during one period of execution of an action, an amount of lateral displacement thereof, an amount of anteroposterior displacement thereof, and the like. Some of the actions may be combined into a single action.

Returning to FIG. 1, the learning device 30 includes a processor 32, a nonvolatile storage device 34, a main memory 36, a transmitter 38, a receiver 40, an input device 42, and a display device 44. The processor may be a CPU. The nonvolatile storage device 34 stores programs executed by the processor 32 and various data items. The main memory 36 stores the programs and data items read from the storage device 34 or various data items generated during learning. The transmitter 38 supplies drive and control signals to the control target 10. The receiver 40 receives observation data from the control target 10. The input device 42 may be a keyboard. The display device 44 may be an LCD. The learning device 30 is also referred to as a computer. The programs stored in the storage device 34 include a program for executing a control parameter learning method. This program is read out of the storage device 34 and stored in the main memory 36.

The learning device 30 may be connected directly to the control target 10 and implemented as a single device to learn about one control target 10. The learning device 30 may be located on a network and configured to learn about a plurality of control targets 10 through the network.

The control target 10 includes a processor 12, a nonvolatile storage device 14, a main memory 16, a sensor 18, a drive device 20, a transmitter 22, and a receiver 24.

The processor 12 may be a CPU. The nonvolatile storage device 14 stores programs executed by the processor 12 and various data items. The main memory stores the programs and data items read from the storage device 14 or various data items generated during learning. The sensor 18 detects the status of the control target 10 itself and the status of the environment surrounding of the control target 10. The drive device 20 drives each movable object of the control target 10. The transmitter 22 supplies the learning device 30 with observation data concerning the status of the control target 10 itself and the status of the environment surrounding of the control target 10. The receiver 24 receives a drive and a control signal from the learning device 30. The sensor 18 is attached to the movable object. The sensor 18 includes a rotation sensor, an acceleration sensor, a gyro sensor, and an infrared sensor that detect the status of the movable object. The sensor 18 may be a camera that detects the surroundings.

The learning device 30 and the control target 10 may be configured to operate in synchronization with each other. The action selection cycle of machine learning is fixed, and the control target 10 may transmit observation data to the learning device 30 for each action selection cycle to match the learning cycle of the learning device 30 with the action selection cycle. After an action is executed and before the next action is executed, the control target 10 may transmit observation data to the learning device 30. Alternatively, the transmitter 22 may transmit observation data to the learning device 30 at all times or in a very short cycle (which is shorter than the action selection cycle).

The control target 10 is not limited to the robotic arm 52, and the first embodiment can be applied to any control target 10 that executes a continuous action. In addition, the control target 10 may be configured by an actual machine or a simulator that executes the same operation as the actual machine.

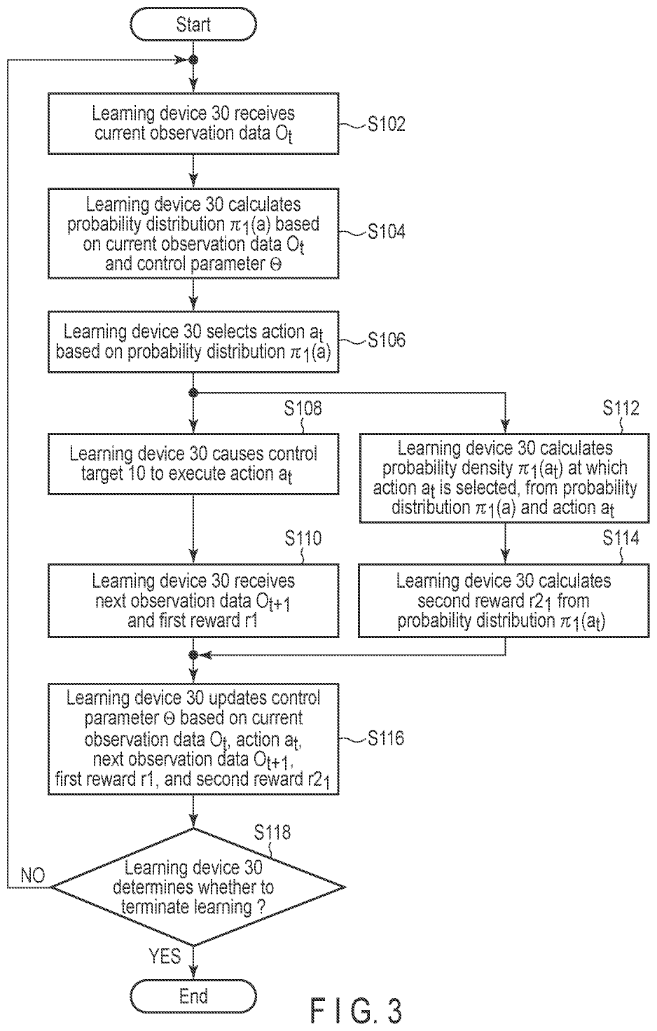

FIG. 3 is a flowchart illustrating an example of a control parameter learning method executed by the learning device 30 according to the first embodiment.

The control parameter learning method includes step S102 of receiving the current observation data, step S104 of calculating a probability distribution Π₁(a) based on the current observation data and control parameter Θ, step S106 of selecting an action aₜ based on the probability distribution Π₁(a), step S108 of causing the control target 10 to execute the action aₜ, step S110 of receiving the next observation data and first reward r1, step S112 of calculating a probability density Π₁(aₜ) at which an action aₜ is selected from the probability distribution Π₁(a) and the action aₜ, step S114 of calculating a second reward r2₁ from the probability density Π₁(aₜ), step S116 of updating the control parameter Θ based on the current observation data, action aₜ, next observation data, first reward r1 and second reward r2₁, and step S118 of determining whether to terminate the learning.

Details of each of the steps will be described below.

### (Step S102: Receiving Current Observation Data)

The learning device 30 receives the current observation data Oₜ.

The observation data Oₜ is a set of values representing the states of the control target 10 and its surrounding environment. The values include, for example, values indicating the position and attitude of the control target 10, attribute information such as the position and size of an object existing around the control target 10, the presence or absence or the existence probability of an object at each position around the control target 10, and values acquired by the sensor 18. The learning device 30 acquires these values from the control target 10 and its surrounding environment.

The observation data may include a history of actions executed in the past.

The control target 10 and its surrounding environment may be the actual control target 10 and its actual surrounding environment or may be simulated control target 10 and surrounding environment.

### (Step S104: Calculating Probability Distribution)

The learning device 30 calculates a probability distribution Π₁(a) based on the current observation data Oₜ, and the control parameter Θ. The probability distribution Π₁(a) is the distribution of probability densities at which the action of value “a” is selected. As the probability distribution, known probability distributions such as a normal distribution, a beta distribution, and truncated normal distribution can be used. Specifically, the learning device 30 calculates the probability distribution Π(a) by calculating a set α of parameters of the probability distribution Π(a) based on the current observation data Oₜ and the control parameter Θ. If, for example, a normal distribution is used as the probability distribution, its parameters are a mean and a variance.

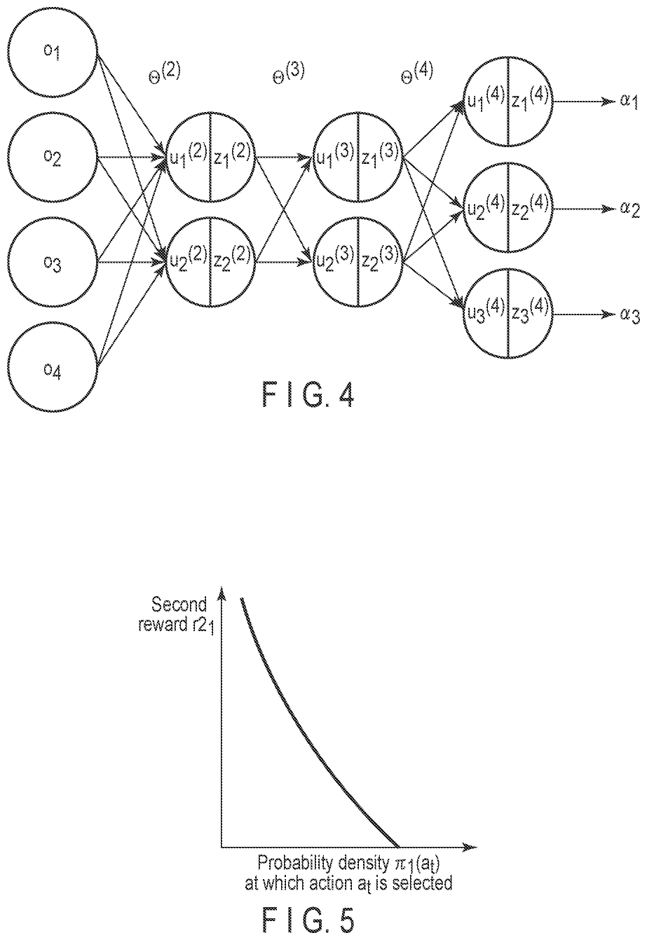

The learning device 30 may calculate the parameters of the probability distribution using a neural network. FIG. 4 is a diagram illustrating an example of a neural network in which the parameters of a probability distribution are calculated. For illustrative purposes, FIG. 4 shows how four values O₁, O₂, O₃, and O₄ are included in the current observation data and three parameters α₁, α₂, and α₃ are calculated. The number of values included in the observation data is not limited to four or the number of parameters is not limited to three. The control parameter Θ is a set of variables that change the input/output characteristics of the neural network to calculate the parameters α₁, α₂, and α₃ of the probability distribution. The control parameter Θ includes the weight of the neural network and the like.

The combination of a convolutional neural network, a recurrent neural networks, and a softmax function, etc., may be used to calculate the parameters of the probability distribution.

In addition, the combination of input/output normalization and addition of randomness to input/output characteristics may be used to calculate the parameters of the probability distribution. The control parameter Θ is stored in the main memory 36.

### (Step S106: Selecting Action)

The learning device 30 selects the action aₜ based on the probability distribution Π(a). Specifically, the learning device 30 stochastically extracts the action according to the probability distribution Π(a) and selects the extracted action as the action aₜ.

### (Step S108: Causing the Control Target to Execute Action)

The learning device 30 causes the control target 10 to execute an action corresponding to the action aₜ. The control target 10 executes an action corresponding to the action aₜ selected by the control parameter learning method according to the first embodiment. Alternatively, the learning device 30 may be configured by the user of the learning device 30 so that the control target 10 executes an action corresponding to the current action aₜ executed by the control parameter learning method according to the first embodiment.

### (Step S110: Receiving Next Observation Data and First Reward)

The learning device 30 receives the next observation data Oₜ₊₁ and the first reward r1.

The observation data Oₜ₊₁ represents the states of the control target 10 and its surrounding environment after the control target 10 executes an action corresponding to the selected action. The states may be the states of a control target 10 corresponding to the current observation data and its surrounding environment aₜ a point in time after only one action execution period from the present time. That is, if the current observation data Oₜ is a set of values representing the states of the control target 10 aₜ time t=t₀ and its surrounding environment, the next observation data Oₜ₊₁ may be a set of values representing the states of the control target 10 aₜ time t=t₀+1 and its surrounding environment.

The first reward r1 is obtained by the control target 10 that has executed an action corresponding to the action selected by the control parameter learning method according to the first embodiment. The first reward r1 represents whether the action executed was appropriate. The learning device 30 learns the selection of action of the control target 10 such that it selects more actions in the states if a reward obtained in the future by executing the actions is large and it selects less actions in the states if the reward is small. When the robotic arm 52 is so controlled that the end effector 54 approaches the item 56, if the end effector 54 is close to the item 56, the first reward r1 is large, and otherwise it is small. The first reward r1 may be given by the control target 10 or its surrounding environment, and may be supplied from the user of the learning device 30 according to the action and its positive or negative results. The first reward r1 may be obtained during a period between time t=t₀ corresponding to the current observation data Oₜ and time t=t₀+1 corresponding to the next observation data Oₜ₊₁.

### (Step S112: Calculating Probability Density)

The learning device 30 executes step S112 in parallel with step S108. The learning device 30 calculates a probability density Π₁(aₜ) at which the action aₜ is selected, from both the probability distribution Π₁(a) calculated in step S104 and the action aₜ selected in step S106. Specifically, the learning device 30 calculates a probability density Π₁(aₜ) at which the action aₜ is selected, by setting the probability distribution Π₁(a) for the action aₜ, that is, the probability distribution Π₁(a) at a=aₜ, as the probability density Π₁(aₜ) at which the action aₜ is selected.

### (Step 114: Calculating Second Reward)

The learning device 30 calculates a second reward r2₁ from the probability density Π₁(aₜ) calculated in step S112. FIG. 5 is a diagram illustrating an example of the relationship between the probability density Π₁(aₜ) at which the action aₜ is selected and the second reward r2₁ calculated in step S114. The learning device 30 calculates the second reward r2₁ so that the second reward r2₁ becomes larger as the probability density Π₁(aₜ) decreases. The learning device 30 may calculate the second reward r2₁ using a lookup table set in advance to obtain a desired input/output relationship, or may calculate the second reward r2₁ by a function as indicated by the following equation, where the second reward r2₁ becomes larger as the probability density Π₁(aₜ) decreases. The lookup table or the function is stored in the main memory 36.

$$r {2}_{1} = - β \cdot log {π}_{1} ( {a}_{t} ) \qquad Equation 1$$

In equation 1, β is any positive constant.

### (Step S116: Updating Control Parameters)

After the completion of steps S110 and S114, the learning device 30 updates the control parameter Θ based on the current observation data Oₜ received in step S102, the action aₜ selected in step S106, the next observation data Oₜ₊₁ and the first reward r1 received in step S110, and the second reward r2₁ calculated in step S114.

The learning device 30 can update the control parameter in the same manner as a method for updating the parameter for use in calculating the probability distribution in the known actor-clitic method by setting the value of addition of the first and second rewards r1 and r2₁ as a reward in the actor-clitic method.

Specifically, the learning device 30 updates the control parameter Θ as follows, based on a difference between an estimate Vₜ of a cumulative reward to be obtained from now to the future and an estimate R of a cumulative reward to be obtained from now to the future due to the execution of the selected current action aₜ.

$$Θ = Θ + η \cdot {∇}_{Θ} log {π}_{1} ( {a}_{t} ) \cdot ( R - {v}_{t} ) \qquad Equation 2$$

In equation 2, ∇_{Θ}logΠ₁(aₜ) is a gradient by the control parameter Θ of the logarithmic value of the probability density Π₁(aₜ) at which the action aₜ is selected, and η is a learning rate.

∇_{Θ}logΠ₁(aₜ) corresponds to the update direction of the control parameter Θ such that the probability density at which the action aₜ is selected becomes large. If, therefore, the estimate R of the cumulative reward to be obtained from now to the future due to the execution of the action aₜ is larger than the estimate Vₜ of the cumulative reward to be obtained from now to the future, the learning device 30 updates the control parameter Θ so that the probability density at which the action aₜ is selected becomes higher. Conversely, if the estimate R is smaller than the estimate Vₜ, the learning device 30 updates the control parameter Θ so that the probability density at which the action aₜ is selected becomes lower.

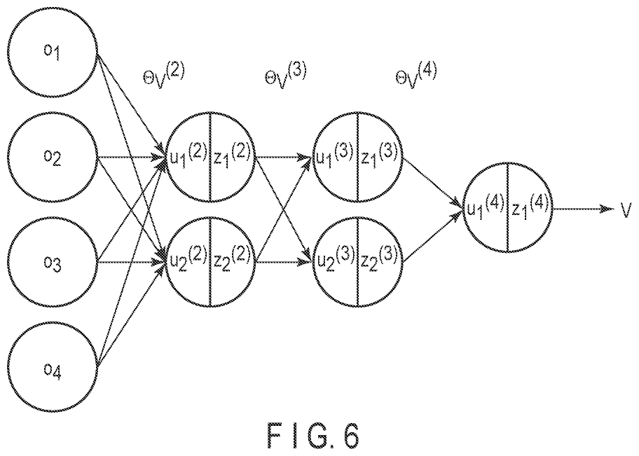

The learning device 30 calculates the estimate Vₜ of the cumulative reward to be obtained from now to the future based on the current observation data Oₜ and the control parameter Θᵥ of the state value function in the same manner as the process of calculating a set a of parameters of the probability distribution based on the observation data and the control parameter Θ. FIG. 6 is a diagram illustrating an example of a neural network to calculate an estimate of a cumulative reward. The state value function is a function of calculating (outputting) an estimate Vₜ of a cumulative reward obtained to the future from the time when the observation data is obtained, based on the observation data (that is, with the observation data as input). The parameter Θᵥ of the state value function is a parameter to determine input/output characteristics of the state value function. Assume that an estimate calculated by the state value function based on the current observation data Oₜ is Vₜ and an estimate calculated by the state value function based on the next observation data Oₜ₊₁ is Vₜ₊₁. The learning device 30 may use a neural network to calculate an estimate Vₜ of a cumulative reward to be obtained from now to the future, similar to the calculation of a set α of parameters of the probability distribution.

The learning device 30 calculates the estimate R of the cumulative reward to be obtained from now to the future due to the execution of the selected action as follows, based on the sum of the first and second rewards r1 and r2₁, an estimate Vₜ₊₁ of reward to be obtained from the next state to the future, and a factor γ.

$$R = ( r 1 + r {2}_{1} ) + γ \cdot {V}_{t + 1} \qquad Equation 3$$

The factor γ is also referred to as a discount rate.

Like in the process of calculating the estimate Vₜ of the cumulative reward to be obtained from now to the future, the learning device 30 calculates an estimate Vₜ₊₁ of reward to be obtained from the next state to the future based on the next observation data Oₜ₊₁ and the parameter Θᵥ of the state value function.

The learning device 30 also updates the parameter Θᵥ of the state value function as follows, with the learning rate as ηᵥ.

$${Θ}_{V} = {Θ}_{V} - η \cdot {∇}_{Θ V} ( R - {V}_{t} ) 2 \qquad Equation 4$$

When step S116 is completed, the learning device 30 determines whether to terminate the learning (step S118).

As described above, the control parameter learning method according to the first embodiment includes step S102 of receiving the current observation data, step S104 of calculating the probability distribution Π₁(a) based on the current observation data and the control parameter Θ, step S106 of selecting the action aₜ based on the probability distribution Π₁(a), step S108 of causing the control target 10 to execute the action aₜ, step S110 of receiving the next observation data and the first reward r1, step S112 of calculating the probability density Π₁(aₜ) at which the action aₜ is selected from the probability distribution Π₁(a) and the action aₜ, step S114 of calculating the second reward r2₁ from the probability density Π₁(aₜ), and step S116 of updating the control parameter Θ based on the current observation data, action aₜ, next observation data, first reward r1, and second reward r2₁. These steps are executed for each cycle of the action execution to learn the control parameters of control of actions of robots, mobile objects and the like.

### (Advantages of First Embodiment)

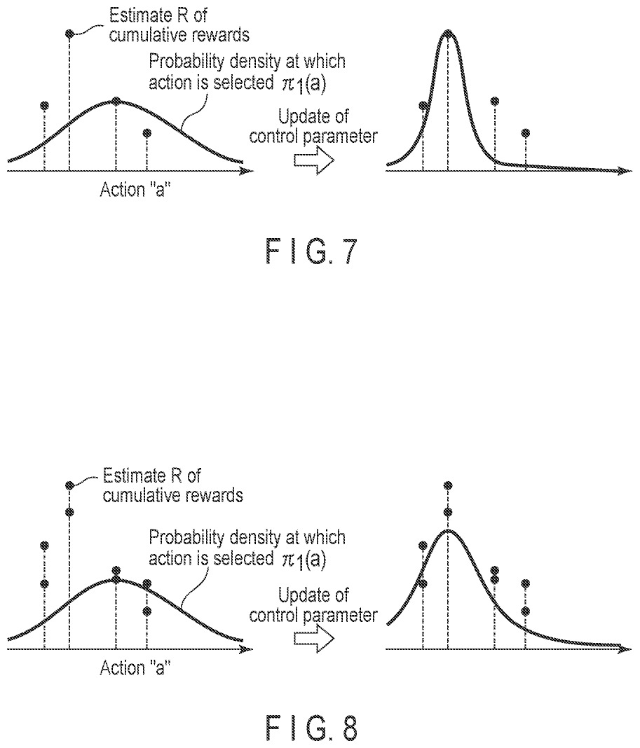

FIG. 7 is a diagram illustrating problems of a general reinforcement learning method. FIG. 8 is a diagram illustrating an example of the advantages of the control parameter learning method according to the first embodiment.

Generally, in the reinforcement learning, if the estimate R of the cumulative reward to be obtained from now to the future due to the execution of a certain action aₜ is relatively large, the control parameter Θ is so updated that the probability density at which the action aₜ is selected increases. Conversely, if the estimate R is relatively small, the control parameter Θ is so updated that the probability density at which the action aₜ is selected decreases. Since, however, the estimate is based upon the information obtained up to a certain point in time, an estimate for a certain action may be underestimated unreasonably in the early stage of learning when there is little information already available. In this general reinforcement learning method, the probability density at which the action is selected is calculated to be unreasonably low, as shown in FIG. 7. The information on the rewards resulting from the execution of the action becomes harder to obtain. The estimate of the cumulative reward resulting from the execution of the action also becomes harder to correct. Therefore, learning converges to a local optimum and accordingly incorrect learning is executed.

In contrast, according to the learning method according to the first embodiment, even if the probability density at which a certain action is selected is calculated to be unreasonably low in the early stage of learning, the second reward due to a low probability density at which the action is selected is added to the first reward. The unreasonably low probability density is corrected as shown in FIG. 8. As a result, learning is prevented from converging to a local optimum to execute incorrect learning.

In addition, according to the first embodiment, the gradient of entropy of the probability distribution need not be calculated. The control parameters are accurately learned, based on the probability distribution, even for a control target having a probability distribution in which the gradient of entropy is difficult to calculate.

Furthermore, according to the first embodiment, the method of updating the control parameters need not be greatly changed from the known reinforcement learning method. It is thus easy to avoid incorrect learning in various known reinforcement learning methods.

Next is a description of a control device, a control method, and a program using the control parameters learned by the learning method according to the first embodiment.

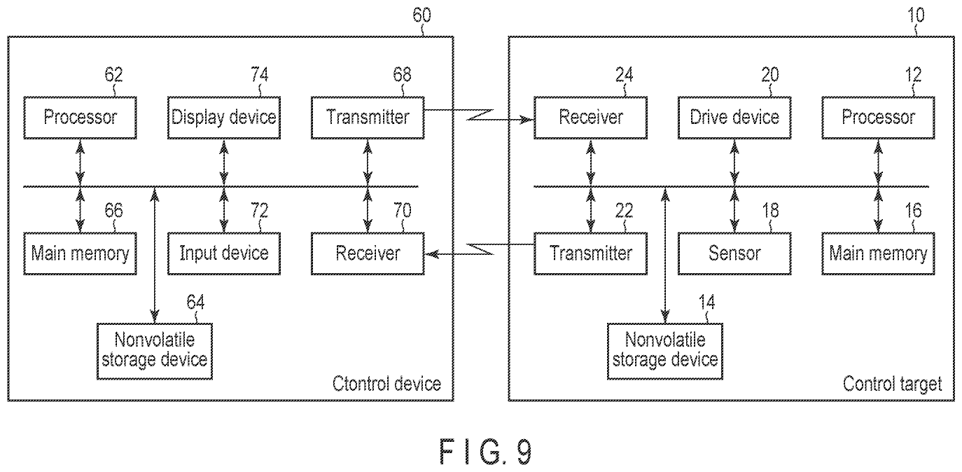

FIG. 9 is a block diagram illustrating an example of a control device 60 that executes the control method according to the first embodiment and an example of the control target 10. The control device 60 includes a processor 62, a storage device 64, a main memory 66, a transmitter 68, a receiver 70, an input device 72, and a display device 74. The processor 62, storage device 64, main memory 66, transmitter 68, receiver 70, input device 72, and display device 74 are almost the same as the processor 32, storage device 34, main memory 36, transmitter 38, receiver 40, input device 42, and display device 44 of the learning device 30. However, the storage device 34 stores learning programs, whereas the storage device 64 stores control programs.

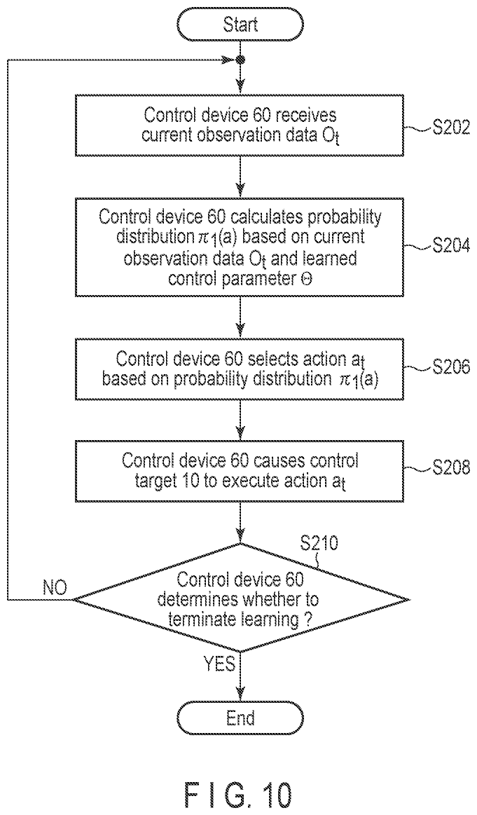

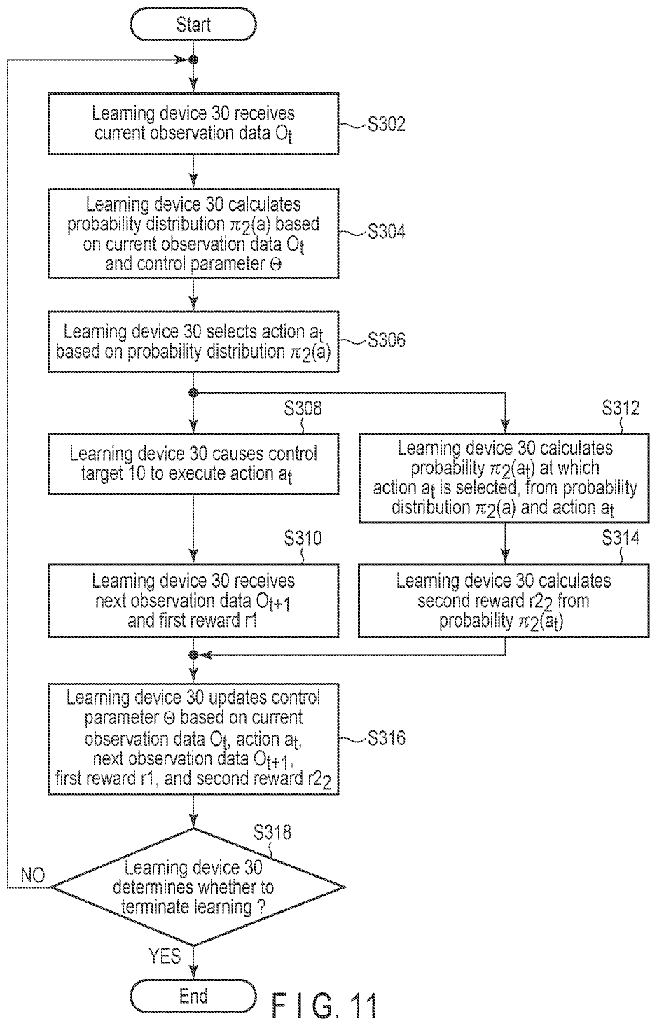

FIG. 10 is a flowchart illustrating an example of a control method to be executed by the control device 60 according to the first embodiment. The control device 60 executes a control program stored in the storage device 64 to achieve the control method.

The control method includes step S202 of receiving the current observation data, step S204 of calculating the probability distribution Π₁(a) based on the current observation data and the control parameter Θ, step S206 of selecting an action aₜ based on the probability distribution Π₁(a), step S208 of causing the control target 10 to execute the action aₜ, and step S210 of determining whether to terminate the control.

In step S202, the control device 60 receives the current observation data Oₜ. Step S202 may be similar to step S102 of receiving the current observation data in the control parameter learning method.

In step S204, the control device 60 calculates the probability distribution Π₁(a) based on the current observation data Oₜ and the control parameter Θ learned by the control parameter learning method according to the first embodiment. Step S204 may be similar to step S104 of calculating the probability distribution in the control parameter learning method.

In step S206, the control device 60 selects the action aₜ based on the probability distribution Π(a). Step S206 may be similar to step S106 of selecting an action in the control parameter learning method. Alternatively, in step S206, the control device 60 may select the action aₜ by setting the average value of action a under the probability distribution Π₁(a) as the action aₜ. Alternatively, in step S206, the control device 60 may select the action aₜ by setting the mode of action “a” under the probability distribution Π₁(a) as the action aₜ.

In step S208, the learning device 30 causes the control target 10 to execute an action corresponding to the action aₜ.

When step S208 is completed, the learning device 30 determines whether to terminate the learning (step S210).

### Second Embodiment

As the first embodiment, a learning device, a learning method, and a learning program in an actor-critic method in which the control target 10 executes a continuous action, and a control device, a control method, and a control program using the learned control parameters have been described. The second embodiment relates to a learning device, a learning method, and a learning program in an actor-critic method in which the control target 10 executes a discrete action, and a control device, a control method, and a control program using the learned control parameters. Since the learning device according to the second embodiment is the same as the learning device 30 according to the first embodiment and the control device according to the second embodiment is the same as the control device 60 according to the first embodiment, the learning device or the control device according to the second embodiment is not shown.

If the control target 10 is the robotic arm 52 (FIG. 2), examples of control of a discrete action include “turn the arm 52 to the right”, “turn the arm 52 to the left” and “fix the arm 52” as shown in FIG. 2A, and “move the end effector 54 to the back”, “move the end effector 54 to the front”, “raise the end effector 54”, “lower the end effector 54”, “shut the end effector 54 and catch the item 56”, “open the end effector 54 and release the item 56”, and the like as shown in FIG. 2B. Some of these actions may be combined into a single action.

FIG. 11 is a flowchart illustrating an example of a control parameter learning method to be executed by the learning device according to the second embodiment.

The control parameter learning method includes step S302 of receiving the current observation data, step S304 of calculating the probability distribution Π₂(a) based on the current observation data and the control parameter Θ, step S306 of selecting the action aₜ based on the probability distribution Π₂(a), step S308 of causing the control target 10 to execute the action aₜ, step S310 of receiving the next observation data and the first reward r1, step S312 of calculating the probability Π₂(aₜ) at which the action aₜ is selected from the probability distribution Π₂(a) and the action aₜ, step S314 of calculating the second reward r2₂ from the probability Π₂(aₜ), step S316 of updating the control parameter Θ based on the current observation data, action aₜ, next observation data, first reward r1, and second reward r2₂, and step S318 of determining whether to terminate the learning.

Details of each of the steps will be described below.

### (Step S302: Receiving Current Observation Data)

The learning device 30 receives the current observation data Oₜ. Step S302 may be similar to step S102 of receiving the current observation data according to the first embodiment.

### (Step S304: Calculating Probability Distribution)

The learning device 30 calculates the probability distribution Π₂(a) based on the current observation data Oₜ and the control parameter Θ. The probability distribution Π₂(a) is the distribution of probabilities that each action a=aₐ, a_{b} . . . executed by the control target 10 is selected.

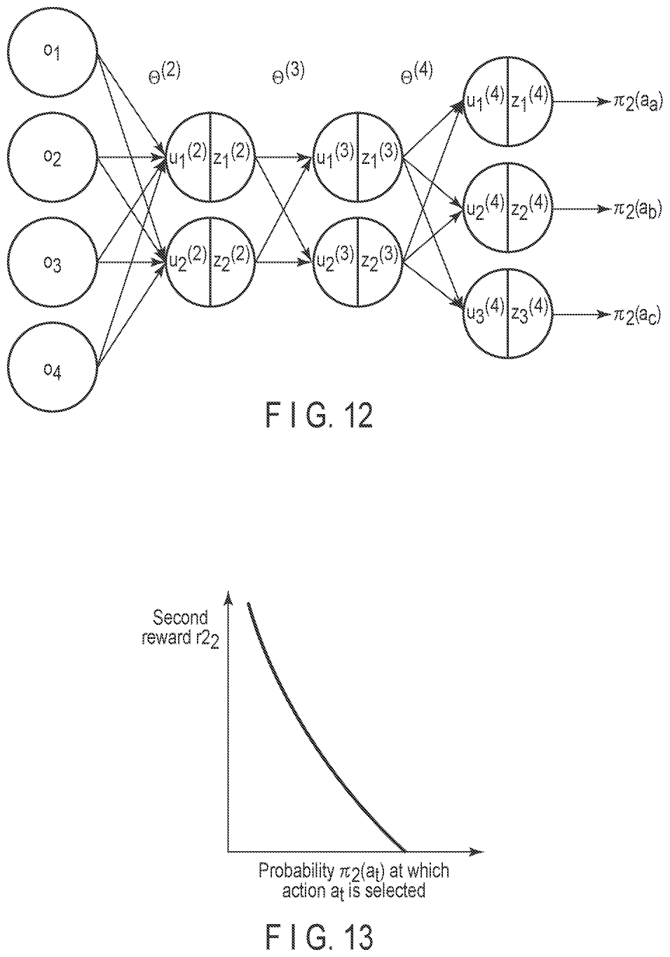

The learning device 30 may calculate the probability distribution Π₂(a) using a neural network. FIG. 12 is a diagram illustrating an example of a neural network to calculate a probability distribution. For illustrative purposes, FIG. 12 shows how four values O₁, O₂, O₃, and O₄ are included in the current observation data and how a probability distribution including probabilities Π₂(aₐ), Π₂(a_{b}), and Π₂(a_{c}) for their respective three actions aₐ, a_{b}, and a_{c} is calculated. The number of values included in the observation data is not limited to four or the number of actions is not limited to three. The control parameter Θ is a set of variables that change the input/output characteristics of the neural network to calculate the probability distribution. The control parameter Θ includes the weight of the neural network and the like.

The combination of a convolutional neural network, a recurrent neural networks, and a softmax function, etc., may be used to calculate the probability distribution.

In addition, the combination of input/output normalization and addition of randomness to input/output characteristics may be used to calculate the probability distribution.

### (Step S306: Selecting Action)

The learning device 30 selects the action aₜ based on the probability distribution Π₂(a). Specifically, the learning device 30 stochastically extracts the action according to the probability distribution Π₂(a) and selects the extracted action as the action aₜ.

### (Step S308: Causing the Control Target 10 to Execute Action)

The learning device 30 causes the control target 10 to execute an action corresponding to the action aₜ. The control target 10 executes an action corresponding to the action aₜ selected by the control parameter learning method according to the second embodiment. Alternatively, the learning device 30 may be configured by the user of the learning device 30 so that the control target 10 executes an action corresponding to the current action aₜ executed by the control parameter learning method according to the second embodiment.

### (Step S310: Receiving Next Observation Data and First Reward)

The learning device 30 receives the next observation data Oₜ₊₁ and the first reward r1. Step S310 may be similar to step S110 of receiving the next observation data and first reward according to the first embodiment.

### (Step S312: Calculating Probability)

The learning device 30 executes step S312 in parallel with step S308. The learning device 30 calculates the probability Π₂(aₜ) at which the action aₜ is selected, from both the probability distribution Π₂(a) calculated in step S304 and the action aₜ selected in step S306. Specifically, the learning device 30 calculates the probability Π₂(aₜ) at which the action aₜ is selected, by setting the probability distribution Π₂(a) in the action aₜ, that is, the probability distribution Π₂(a) at a=aₜ, as the probability Π₂(aₜ) at which the action aₜ is selected.

### (Step 314: Calculating Second Reward)

The learning device 30 calculates a second reward r2₂ from the probability Π₂(aₜ) calculated in step S312. FIG. 13 is a diagram illustrating an example of the relationship between the probability Π₂(aₜ) at which the action aₜ is selected and the second reward r2₂. The learning device 30 calculates the second reward r2₂ so that the second reward r2₂ becomes larger as the probability Π₂(aₜ) decreases. The learning device 30 may calculate the second reward r2₂ using a lookup table set in advance to obtain a desired input/output relationship, or may calculate the second reward r2₂ by a function as indicated by the following equation, where the second reward r2₂ becomes larger as the probability Π₂(aₜ) decreases.

$$r {2}_{2} = - β \cdot log {π}_{2} ( {a}_{t} ) \qquad Equation 5$$

In equation 5, β is any positive constant.

### (Step S316: Updating Control Parameters)

After the completion of steps S310 and S314, the learning device 30 updates the control parameter Θ based on the current observation data Oₜ received in step S302, the action aₜ selected in step S306, the next observation data Oₜ₊₁ received in step S310, and the first reward r1 and the second reward r2₂ calculated in step S314.

The learning device 30 can update the control parameter in the same manner as a method for updating the parameter for use in calculating the probability distribution in the known actor-clitic method by setting the value of addition of the first and second rewards r1 and r2₂ as a reward in the actor-clitic method.

The learning device 30 updates the control parameter Θ as follows, based on a difference between an estimate Vₜ of a cumulative reward to be obtained from now to the future and an estimate R of a cumulative reward to be obtained from now to the future due to the execution of the selected current action aₜ.

$$Θ = Θ + η \cdot {∇}_{Θ} log {π}_{2} ( {a}_{t} ) \cdot ( R - {V}_{t} ) \qquad Equation 6$$

In equation 6, ∇_{Θ}logΠ₂(aₜ) is a gradient by the control parameter Θ of the logarithmic value of the probability Π₂(aₜ) at which the action aₜ is selected, and r1 is a learning rate.

∇_{Θ}logΠ₂(aₜ) corresponds to the update direction of the control parameter Θ such that the probability at which the action aₜ is selected becomes large. If, therefore, the estimate R of the cumulative reward to be obtained from now to the future due to the execution of the action aₜ is larger than the estimate Vₜ of the cumulative reward to be obtained from now to the future, the learning device 30 updates the control parameter Θ so that the probability at which the action aₜ is selected becomes higher. Conversely, if the estimate R is smaller than the estimate Vₜ, the learning device 30 updates the control parameter Θ so that the probability at which the action aₜ is selected becomes lower.

The learning device 30 calculates the estimate Vₜ of the cumulative reward to be obtained from now to the future based on the current observation data Oₜ and the parameter Θᵥ of the state value function in the same manner as the process of calculating the probability distribution Π₂(a) based on the observation data and the control parameter Θ. The learning device 30 may use a neural network to calculate an estimate Vₜ of a cumulative reward to be obtained from now to the future, similar to the calculation of the probability distribution Π₂ (a).

The learning device 30 calculates the estimate R of the cumulative reward to be obtained from now to the future due to the execution of the selected action as follows, based on the sum of the first and second rewards r1 and r2₂ and an estimate Vₜ₊₁ of reward to be obtained from the next state to the future.

$$R = ( r 1 + r {2}_{2} ) + γ \cdot {V}_{t + 1} \qquad Equation 7$$

In equation 7, γ is a factor (also referred to as a discount rate).

Like in the process of calculating the estimate Vₜ of the cumulative reward to be obtained from now to the future, the learning device 30 calculates the estimate Vₜ₊₁ of the cumulative reward to be obtained from the next state to the future based on the next observation data Oₜ₊₁ and the parameter Θᵥ of the state value function.

The learning device 30 also updates the parameter Θᵥ of the state value function as follows.

$${Θ}_{V} = {Θ}_{V} - {η}_{V} \cdot {∇}_{Θ V} {( R - {V}_{t} )}^{2} \qquad Equation 8$$

In equation 8, ηᵥ is a coefficient (also referred to as a learning rate).

When step S310 or S314 is completed, the learning device 30 determines whether to terminate the learning (step S318).

As described above, the control parameter learning method according to the second embodiment includes step S302 of receiving the current observation data, step S304 of calculating the probability distribution Π₂(a) based on the current observation data and the control parameter Θ, step S306 of selecting the action aₜ based on the probability distribution Π₂(a), step S308 of causing the control target 10 to execute the action aₜ, step S310 of receiving the next observation data and the first reward r1, step S312 of calculating the probability Π₂(aₜ) at which the action aₜ is selected from the probability distribution Π₂(a) and the action aₜ, step S314 of calculating the second reward r2₂ from the probability Π₂(aₜ), and step S316 of updating the control parameter Θ based on the current observation data, action aₜ, next observation data, and first reward r1 and second reward r2₂. These steps are executed for each cycle of the action execution to learn the control parameters of control of actions of robots, mobile objects, and the like.

In the learning method according to the second embodiment, when the control target 10 executes a discrete action, if the probability at which a certain action is selected in the early stage of learning is calculated to be unreasonably low, a second reward due to the unreasonably low probability is added to the first reward, and the unreasonably low probability is corrected. As a result, incorrect learning is avoided.

In addition, even in the second embodiment, it is unnecessary to calculate the gradient of entropy of the probability distribution. Therefore, the control parameters are accurately learned based on the probability distribution even for a control target having a probability distribution in which the gradient of entropy is difficult to calculate.

Furthermore, even in the second embodiment, it is unnecessary to significantly change the method of updating the control parameters for the known reinforcement learning method. It is thus easy to avoid incorrect learning in various known reinforcement learning methods.

The control device, control method, and program using the control parameters learned by the learning method according to the second embodiment are configured in the same manner as the control device, control method, and program according to the first embodiment. The process flow of the control method according to the second embodiment is the similar to that in FIG. 10.

The control device 60 receives the current observation data Oₜ. The step of receiving the current observation data Oₜ may be similar to step S302 of receiving the current observation data in the control parameter learning method.

The control device 60 calculates a probability distribution Π₂(a) based on the current observation data Oₜ and the control parameter Θ learned by the control parameter learning method. The step of calculating the probability distribution Π₂(a) may be the same as step S304 of calculating the probability distribution in the control parameter learning method.

The control device 60 selects the action aₜ based on the probability distribution Π₂(a). The step of selecting action aₜ may be similar to step S306 of selecting an action in the control parameter learning method. Alternatively, the control device 60 may select the action aₜ by setting the average value of action “a” under the probability distribution Π₂(a) to the action aₜ. Alternatively, the control device 60 may select the action aₜ by setting the mode of action “a” under the probability distribution Π₂(a) as the action aₜ.

### Third Embodiment

In the first and second embodiments, a learning device, a learning method, and a learning program using an actor-critic method as an example of the reinforcement learning method, and a control device, a control method, and a control program using the learned control parameters have been described. The third embodiment is directed to a learning device, a learning method, and a learning program using an SARSA method as an example of the reinforcement learning method, and a control device, a control method, and a control program using the learned control parameters. Like the actor-clitic method, the SARSA method is applicable to both a control target that executes a continuous action and a control target that executes a discrete action.

The learning device according to the third embodiment is the same as the learning device 30 according to the first embodiment. The control device according to the third embodiment is the same as the control device 60 according to the first embodiment. Neither of the learning device and control device according to the third embodiment is illustrated.

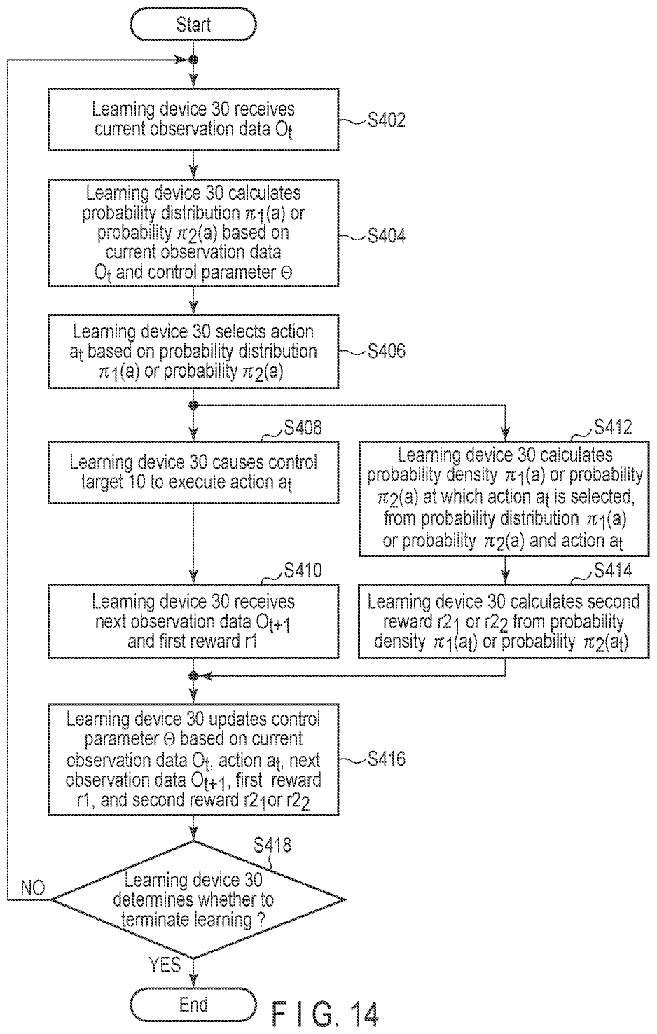

FIG. 14 is a flowchart illustrating an example of a control parameter learning method to be executed by the learning device according to the third embodiment.

The control parameter learning method includes step S402 of receiving the current observation data, step S404 of calculating the probability distribution Π₁(a) or probability Π₂(a) based on the current observation data and the control parameter Θ, step S406 of selecting the action aₜ based on the probability distribution Π₁(a) or probability Π₂(a), step S408 of causing the control target 10 to execute the action aₜ, step S410 of receiving the next observation data and the first reward r1, step S412 of calculating the probability density Π₁(aₜ) or probability Π₂(aₜ) at which the action aₜ is selected from the probability distribution Π₁(a) or probability Π₂(a) and the action aₜ, step S414 of calculating the second reward r2₁ from the probability density Π₁(aₜ) or calculating the second reward r2₂ from the probability Π₂(aₜ), step S416 of updating the control parameter Θ based on the current observation data, action aₜ, next observation data, first reward r1 and second reward r2₁ or r2₂, and step S418 of determining whether to terminate the learning.

If the control target 10 executes a continuous action, the probability distribution Π(a), probability density Π₁(aₜ), and second reward r2₁ are calculated. If the control target 10 executes a discrete action, the probability distribution Π₂(a), probability Π₂(aₜ), and second reward r2₂ are calculated.

Details of each of the steps will be described below.

### (Step S402: Receiving Current Observation Data)

The learning device 30 receives the current observation data Oₜ in step S402. Step S402 may be similar to step S102 of receiving the current observation data according to the first embodiment or step S302 of receiving the current observation data according to the second embodiment.

### (Step S404: Calculating Probability Distribution)

The learning device 30 calculates the probability distribution Π₁(a) or probability Π₂(a) based on the current observation data Oₜ and the control parameter Θ. The learning device calculates the probability distribution Π₁(a) if the control target 10 executes a continuous action. The learning device calculates the probability distribution Π₂(a) if the control target 10 executes a discrete action.

Specifically, first, the learning device 30 calculates an action value Q(a) regarding the action “a” based on the current observation data Oₜ and the control parameter Θ. The action value Q(a) indicates an estimate of a cumulative reward to be obtained from now to the future due to the execution of the action “a”.

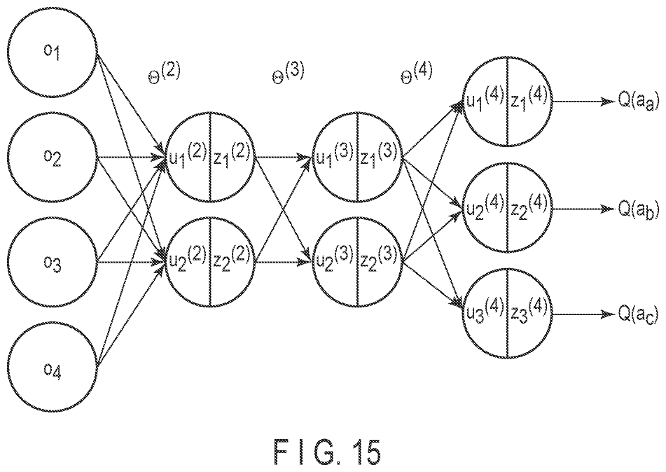

The learning device 30 may calculate the action value Q(a) using a neural network. FIG. 15 is a diagram illustrating an example of a neural network to calculate the action value Q(a) when the control target 10 executes a discrete action. For illustrative purposes, FIG. 15 shows how four values O₁, O₂, O₃, and O₄ are included in the current observation data and how three action values Q(aₐ), Q(a_{b}), and Q(a_{c}) are calculated. The number of values included in the observation data is not limited to four or the number of action values is not limited to three. The control parameter Θ is a set of variables that change the input/output characteristics of the neural network to calculate the action values. The control parameter Θ includes the weight of the neural network and the like.

The combination of a convolutional neural network, a recurrent neural networks, a softmax function, etc., may be used to calculate the action values.

The combination of input/output normalization and addition of randomness to input/output characteristics may be used to calculate the action values.

FIG. 15 is a diagram showing the calculation of action values by a neural network in the case of control of a discrete action. To calculate action values by a neural network in the case of control of a continuous action, the normalized advantage functions method (GU Shixiang et al., “Continuous Deep Q-Learning with Model-based Acceleration”, International Conference on Machine Learning, PMLR, 2016, pp. 2829-2838) can be used.

The learning device 30 then calculates the probability distribution Π(a) based on the action value Q(a) for action “a”. To control the discrete action, the learning device 30 calculates the probability distribution Π₂(a) from the action value Q(a) using the softmax function as given by the following equation.

$$π ( a ) = exp ( Q ( a ) ) / {\sum }_{j}^{K} exp ( Q ( {a}_{j} ) ) \qquad Equation 9$$

In equation 9, K is the number of actions.

To control the continuous action, the learning device 30 calculates the probability distribution Π₁(a).

$$π ( a ) = exp ( Q ( a ) ) / {\int }_{- ∞}^{∞} exp ( Q ( a ) ) da \qquad Equation 10$$

### (Step S406: Selecting Action)

The learning device 30 selects the action aₜ based on the probability distribution Π₁(a) or probability Π₂(a) in step S406. Step S406 may be similar to action selecting step S106 according to the first embodiment or action selecting step S306 according to the second embodiment.

### (Step S408: Causing Control Target 10 to Execute Action)

The learning device 30 causes the control target 10 to execute an action corresponding to the action aₜ in step S408. Step S408 may be similar to step S108 according to the first embodiment or step S308 according to the second embodiment.

### (Step S410: Receiving Next Observation Data and First Reward r1)

The learning device 30 receives the next observation data Oₜ₊₁ and the first reward r1 in step S410. Step S410 may be similar to step S110 according to the first embodiment or step S310 according to the second embodiment.

### (Step S412: Calculating Probability Density or Probability)

The learning device 30 executes step S412 in parallel with step S408. The learning device 30 calculates the probability density Π₁(a) or probability Π₂(a) at which the action aₜ is selected, from the probability distribution Π₁(a) or probability Π₂(a) calculated in step S404 and the action aₜ selected in step S406. The learning device 30 calculates a probability density as in step S112 according to the first embodiment and calculates probability as in step S312 according to the second embodiment.

### (Step S414: Calculating Second Reward)

In step S414, the learning device 30 calculates a second reward r2₁ or r2₂ from the probability density Π₁(aₜ) or probability Π₂(aₜ) calculated in step S412. Step S414 may be similar to step S114 according to the first embodiment in the case of control of a continuous action and may be similar to step S314 according to the second embodiment in the case of control of a discrete action.

### (Step S416: Updating Control Parameter)

After the completion of steps S410 and S414, the learning device 30 updates the control parameter Θ based on the current observation data Oₜ received in step S402, action aₜ selected in step S406, next observation data Oₜ₊₁ received in step S410, first reward r1, and second reward r2₁ or r2₂ calculated in step S414.

Specifically, the learning device 30 can employ a parameter updating method similar to a method for updating a parameter for use in calculating an action value in the known SARSA method by setting the value of addition of the second reward r2₁ or r2₂ to the first reward r1 as a reward in the known SARSA method.

The learning device 30 first selects the next action aₜ₊₁ based on the next observation data Oₜ₊₁ and control parameter Θ by the same method as in step S406 of selecting an action.

The learning device 30 then updates the control parameter Θ as given by the following equation, based on the action value Q(aₜ) regarding the current action aₜ, the sum of the first reward r1 and the second reward r2₁ or r2₂, the action value Q(aₜ₊₁) regarding the next action aₜ₊₁, and the factor γ.

$${Θ}_{V} = {Θ}_{V} - η \cdot {∇}_{Θ} {( ( r 1 + r {2}_{1} ( or r 1 + r {2}_{2} ) ) + γ \cdot Q ( {a}_{t + 1} ) - Q ( {a}_{t} ) )}^{2} \qquad Equation 11$$

In equation 11, γ and η are coefficients, γ is also referred to as a discount rate, and η is also referred to as a learning rate.

When step S416 is completed, the learning device 30 determines whether to terminate the learning (step S418).

As described above, the control parameter learning method according to the third embodiment includes step S402 of receiving the current observation data, step S404 of calculating the probability distribution Π₁(a) or probability Π₂(a) based on the current observation data and the control parameter Θ, step S406 of selecting the action aₜ based on the probability distribution Π₁(a) or probability Π₂(a), step S408 of causing the control target 10 to execute the action aₜ, step S410 of receiving the next observation data and the first reward r1, step S412 of calculating the probability density Π₁(aₜ) or probability Π₂(aₜ) at which the action aₜ is selected from the probability distribution Π₁(a) or probability Π₂(a) and the action aₜ, step S414 of calculating the second reward r2₁ or r2₂ from the probability density Π₁(aₜ) or probability Π₂(aₜ), and step S416 of updating the control parameter Θ based on the current observation data, action aₜ, next observation data, first reward r1, and second reward r2₁ or r2₂. These steps are executed for each cycle of the action execution to learn the control parameters of control of actions of robots, mobile objects and the like.

The control device, control method, and program using the control parameters learned by the learning method according to third embodiment are configured in the same manner as the control device, control method, and program according to the first embodiment. The flow of process of the control method according to the third embodiment is the same as that shown in FIG. 10.

The control device 60 receives the current observation data Oₜ. The step of receiving the current observation data may be similar to step S402 of receiving the current observation data in the control parameter learning method.

The control device 60 calculates the probability distribution Π₁(a) or probability Π₂(a) based on the current observation data Oₜ and the control parameter Θ learned by the control parameter learning method. The step of calculating the probability distribution or probability may be similar to step S404 of calculating the probability distribution or probability in the control parameter learning method.

The control device 60 selects the action aₜ based on the probability distribution Π₁(a) or probability Π₂(a). The step of selecting the action may be similar to step S406 of selecting the action in the control parameter learning method. Alternatively, the control device 60 may select the action aₜ by setting the average action “a” under the probability distribution Π₁(a) or probability Π₂(a) as the action aₜ. Alternatively, the control device 60 may select the action aₜ by setting the mode of the action “a” under the probability distribution Π₁(a) or probability Π₂(a) as the action aₜ.

In the reinforcement learning method using the SARSA method according to the third embodiment, even when the control target 10 executes a continuous action or a discrete action, if the probability at which a certain action is selected in the early stage of learning is calculated to be unreasonably low, a second reward due to the unreasonably low probability is added to the first reward, and the unreasonably low probability is corrected. As a result, incorrect learning is avoided.

### Fourth Embodiment

In the first to third embodiments, the control target 10 is the robotic arm 52, but the control target 10 is not limited to the robotic arm, but may be a movable object including other manufacturing devices. The control target 10 may be a mobile object such as automobiles. Examples of control of continuous actions in automobiles and the like include control of steering angle, control of acceleration, control of deceleration and the like. Examples of control of discrete actions in automobiles and the like include selection of action “go straight” or “change to the right lane” or “change to the left lane”, selection of action “accelerate” or “decelerate” or “move with constant velocity”, and the like. Examples of mobile objects include not only automobiles but also mobile objects such as self-propelled robots, drones, and railroad trains.

### Fifth Embodiment

In the control parameter learning method according to each of the first to third embodiments, in order to compensate for the fact that the probability density or probability at which an action is selected in the early stage of learning is calculated to be unreasonably low, the second reward whose value increases as the probability density or probability at which an action is selected lowers, is added to the first reward. As a result, the unreasonable low probability density or probability is corrected. In the fifth embodiment, instead of correcting the first reward r1 by adding the second reward r2₁ or r2₂ to the first reward r1, the first reward r1 is corrected by multiplying the first reward r1 by correction factor w. That is, in the fifth embodiment, the control parameters are updated based on w×r1 instead of r1+r2₁ (or r2₂) in the first to third embodiments. The correction factor w is predetermined to satisfy that r1+r2₁ (or r2₂) is equal to w×r1 in accordance with the probability density or probability at which an action is selected. The correction factor w is stored in the main memory 36.

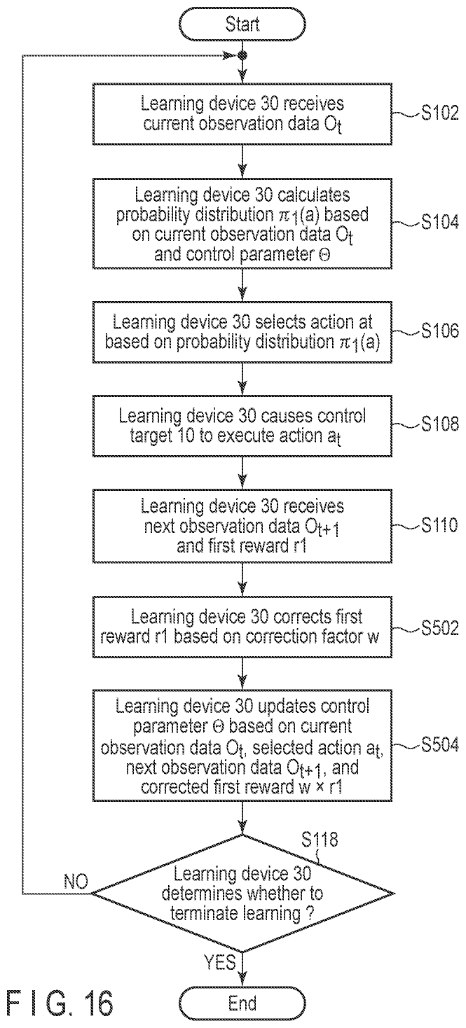

The example of the learning device according to the fifth embodiment is the same as the learning device 30 according to the first embodiment (FIG. 1). FIG. 16 is a flowchart illustrating an example of the learning method according to the fourth embodiment. The process from step S102 of receiving the current observation data to step S110 of receiving the next observation data and the first reward r1 is the same as that of the learning method (FIG. 3) according to the first embodiment.

When step S110 is completed, the learning device 30 corrects the first reward r1 based on the correction factor w (step S502). Like the second reward, the correction factor w increases as the probability density or probability decreases. Thus, the first reward is corrected so that it increases as the probability density or probability decreases. This prevents learning from converging to a local optimum and making incorrect learning even in the early stage of reinforcement learning.

When step S502 is completed, the learning device 30 updates the control parameter Θ based on the current observation data Oₜ, selected action aₜ, next observation data Oₜ₊₁, and corrected first reward w×r1 (step S504). Step S504 can be implemented by replacing the first reward r1 with the corrected first reward w×r1 or replacing the sum of the first reward r1 and the second reward r2₁ or r2₂ (r1+r2₁ (or r1+r2₂)) with the corrected first reward w×r1 in step S116 of the learning method according to the first embodiment, step S316 of the learning method according to the second embodiment, and step S416 of the learning method according to the third embodiment. If step S504 is implemented using the corrected first reward w×r1 instead of the first reward r1 in step S116 of the learning method according to the first embodiment, step S316 of the learning method according to the second embodiment, or step S416 of the learning method according to the third embodiment, the second reward r2₁ or r2₂ need not be used in step S504.

When step S504 is completed, the learning device 30 determines whether to terminate the learning (step S118).

FIG. 16 shows a learning method according to the fifth embodiment as a modification to the first embodiment. In the fifth embodiment as a modification to the second embodiment, the process from step S102 of receiving the current observation data to step S110 of receiving the next observation data and the first reward r1 in FIG. 16 is replaced with the process from steps S302 to step S310 in the learning method according to the second embodiment (FIG. 11). In the fifth embodiment as a modification to the third embodiment, the process from step S102 of receiving the current observation data to step S110 of receiving the next observation data and the first reward r1 in FIG. 16 is replaced with the process from step S402 to step S410 of the learning method according to the third embodiment (FIG. 14).

The fifth embodiment also brings about advantages similar to those of the first to third embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning method comprising:
a first step of receiving current observation data;
a second step of calculating a probability distribution indicating a distribution of a probability density or a distribution of a probability at which actions are selected, based on the current observation data and a control parameter;
a third step of selecting a first action among the actions based on the probability distribution;
a fourth step of causing a control target to execute the first action;
a fifth step of receiving a first reward and next observation data observed after the control target has executed the first action;
a sixth step of calculating a probability density or a probability of the first action from the probability distribution;
a seventh step of correcting the first reward based on a probability density of the first action or a probability of the first action; and
an eighth step of updating the control parameter based on the current observation data, the first action, the next observation data, and the corrected first reward,
wherein the seventh step comprises correcting the first reward such that the first reward increases as the probability density or probability decreases.

2. The learning method of claim 1, wherein the eighth step comprises updating the control parameter for each control period of the control target.

3. The learning method of claim 1, wherein the second step comprises inputting the current observation data to a neural network whose input/output characteristics vary according to the control parameter, the neural network outputting the probability distribution.

4. The learning method of claim 1, wherein the first reward indicates whether selection of the first action is appropriate.

5. The learning method of claim 1, wherein:
the seventh step comprises correcting the first reward by adding a second reward to the first reward; and
the second reward increases as the probability density or probability decreases.

6. The learning method of claim 1, wherein:
the seventh step comprises correcting the first award by multiplying the first reward by a factor; and
the factor increases as the probability density or probability decreases.

7. A learning device comprising a processor configured to:
receive current observation data;
calculate a probability distribution indicating a distribution of a probability density or a distribution of a probability at which actions are selected, based on the current observation data and a control parameter;
select a first action among the actions based on the probability distribution;
cause a control target to execute the first action;
receive a first reward and next observation data observed after the control target has executed the first action;
calculate a probability density or a probability of the first action from the probability distribution;
correct the first reward based on a probability density of the first action or a probability of the first action; and
correct the control parameter based on the current observation data, the first action, the next observation data, and the corrected first reward,
wherein processor is configured to correct the first reward such that the first reward increases as the probability density or probability decreases.

8. A non-transitory computer-readable storage medium storing computer-executable instructions that, when executed, cause the computer to:
receive current observation data;
calculate a probability distribution indicating a distribution of a probability density or a distribution of a probability at which actions are selected, based on the current observation data and a control parameter;
select a first action among the actions based on the probability distribution;
cause a control target to execute the first action;
receive a first reward and next observation data observed after the control target has executed the first action;
calculate a probability density or a probability of the first action from the probability distribution;
correct the first reward based on a probability density of the first action or a probability of the first action; and
correct the control parameter based on the current observation data, the first action, the next observation data, and the corrected first reward,
wherein processor is configured to correct the first reward such that the first reward increases as the probability density or probability decreases.

9. A control method comprising:
a first step of receiving current observation data;
a second step of calculating a probability distribution indicating a distribution of a probability density or a distribution of a probability at which actions are selected, based on the current observation data and a control parameter updated by the learning method of claim 1;
a third step of selecting a first action among the actions based on the probability distribution; and
a fourth step of causing a control target to execute the first action.

10. A control device comprising a processor configured to:
receive current observation data;
calculate a probability distribution indicating a distribution of a probability density or a distribution of a probability at which actions are selected, based on the current observation data and a control parameter;
select a first action among the actions based on the probability distribution; and
cause a control target to execute the first action, wherein
the control parameter is calculated based on the current observation data and the control parameter,
the control parameter is updated based on the probability distribution and a reward indicating whether selection of the first action is appropriate, and
the reward is corrected such that the reward increases as the probability density or probability decreases.

11. A non-transitory computer-readable storage medium storing computer-executable instructions that, when executed, cause a computer to:
receive current observation data;
calculate a probability distribution indicating a distribution of a probability density or a distribution of a probability at which actions are selected, based on the current observation data and a control parameter;
select a first action among the actions based on the probability distribution; and
cause a control target to execute the first action, wherein
the control parameter is calculated based on the current observation data and the control parameter,
the control parameter is updated based on the probability distribution and a reward indicating whether selection of the first action is appropriate, and
the reward is corrected such that the reward increases as the probability density or probability decreases.
